(19) United States
(12) Patent Application Publication
(10) Pub. No.: US 2023/0236801 A1
(43) Pub. Date: Jul. 27, 2023

(54) LOW-LATENCY POLYNOMIAL MODULO MULTIPLICATION OVER RING

(71) Applicants: Regents of the University of Minnesota, Minneapolis, MN (US); Ohio State Innovation Foundation, Columbus, OH (US); Clemson University Research Foundation, Clemson, SC (US)

(72) Inventors: Keshab K. Parhi, Minneapolis, MN (US); Xinmiao Zhang, Columbus, OH (US); Weihang Tan, Foshan City (CN); Antian Wang, Shanghai (CN); Yingjie Lao, Clemson, SC (US)

(21) Appl. No.: 17/582,560

(22) Filed: Jan. 24, 2022

(51) Int. Cl. G06F 7/72; G06F 7/544

(52) U.S. Cl. CPC G06F 7/722; G06F 7/5443

(57) ABSTRACT

A modular polynomial multiplier includes a plurality of processing elements. Each includes a multiplication unit, an addition unit and a delay unit. The addition unit has an input connected to the output of the multiplication unit. The delay unit is connected to the output of the addition unit delays values by one clock cycle. The first input of the multiplication unit of each processing element carries a respective coefficient of a first polynomial and the second input of the multiplication unit of each processing element is connected to one of an input line carrying a sequence of coefficients of a second polynomial having n coefficients and a delay line carrying the sequence of coefficients of the second polynomial delayed by n clock cycles and negated.

### BACKGROUND

Modular polynomial multiplication involves determining the product of two polynomials of order n or less and then determining the modulo (xⁿ+1) of the product. Such modular polynomial multiplication is used in cryptography with values of n equal to or greater than 256. In the discussion below, a modular polynomial product is the polynomial resulting from determining the modulo (xⁿ+1) of a product of two polynomials. A device that determines a modular polynomial product is referred to as a modular polynomial multiplier.

The discussion above is merely provided for general background information and is not intended to be used as an aid in determining the scope of the claimed subject matter. The claimed subject matter is not limited to implementations that solve any or all disadvantages noted in the background.

### SUMMARY

A modular polynomial multiplier includes a plurality of processing elements. Each processing element includes a multiplication unit, an addition unit and a delay unit. The multiplication unit has a first input, a second input and an output, wherein with each of a series of clock cycles, the output of the multiplication unit carries the product of a value provided on the first input and a value provided on the second input. The addition unit has a first input, a second input and an output wherein the first input is connected to the output of the multiplication unit. The delay unit has an input connected to the output of the addition unit and an output, wherein the input carries an input value and the output provides the input value delayed by one clock cycle. The first input of the multiplication unit of each processing element carries a respective coefficient of a first polynomial and the second input of the multiplication unit of each processing element is connected to one of an input line carrying a sequence of coefficients of a second polynomial having n coefficients and a delay line carrying the sequence of coefficients of the second polynomial delayed by n clock cycles and negated.

In accordance with a further embodiment, a modular polynomial multiplier includes a first modular polynomial multiplier configured to produce a first modular product of a first portion of a first polynomial and a first portion of a second polynomial, the first modular product produced as a first series of coefficients with a separate coefficient at each of a set of clock cycles. A second modular polynomial multiplier is configured to produce a second modular product of a second portion of the first polynomial and a second portion of the second polynomial, the second modular product produced as a second series of coefficients with a separate coefficient at each of the set of clock cycles. A first delay circuit is configured to delay the first series of coefficients by one clock cycle to form a delayed series of coefficients and a second delay circuit is configured to delay a first coefficient in the second series of coefficients by a number of clock cycles equal to the number of coefficients in the second series of coefficients to form a modified series of coefficients. An addition unit is configured to add coefficients in the delayed series of coefficients to coefficients in the modified series of coefficients.

In accordance with a still further embodiment, a modular polynomial multiplier includes a first circuit receiving a first sub-polynomial of a first polynomial and a first sub-polynomial of a second polynomial and producing a modular product of the first sub-polynomial of the first polynomial and the first sub-polynomial of the second polynomial. A second circuit receives a second sub-polynomial of the first polynomial and a second sub-polynomial of the second polynomial and produces a modular product of the second sub-polynomial of the first polynomial and the second sub-polynomial of the second polynomial. The first circuit and the second circuit are identical to each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a dependence graph (DG) of a modular polynomial multiplication for the n=4 example.

FIG. 2 is a block diagram of a systolic modular polynomial multiplier of a first embodiment.

FIG. 3 is a block diagram of a fast 2-parallel modular polynomial multiplier of a further embodiment.

FIG. 4(a) is a timing chart showing the alignment of coefficients of U(y) and V(y).

FIG. 4(b) is a timing chart showing the alignment of coefficients of U(y) and V(y) after U(y) is delayed by one clock cycle.

FIG. 4(c) is a timing chart showing the alignment of coefficients of U(y) and V(y) after U(y) is delayed by one clock cycle and the first coefficient of V(y) is delayed n clock cycles and is negated.

FIG. 5 is a block diagram of a fast 3-parallel modular polynomial multiplier of a further embodiment.

FIG. 6 is a block diagram of a fast 4-parallel modular polynomial multiplier of a further embodiment.

### DETAILED DESCRIPTION

The embodiments described below improve the response time and latency of systems that perform modular polynomial multiplication. The response time is defined as the number of clock cycles between when a first coefficient of a polynomial is input to the system and when a first coefficient of the modular polynomial product is output. Latency is defined as the number of clock cycles between when the first coefficient of the polynomial is input to the system and when the last coefficient of the modular polynomial product is output.

In accordance with one embodiment, a modular polynomial multiplier with a sequential weight-stationary systolic structure is used for modular polynomial multiplication. This structure achieves low latency and full hardware utilization. In a further embodiment, a low-latency fast-parallel modular polynomial multiplication architecture is used for modular polynomial multiplication that integrates a modular reduction at a merging level. In a still further embodiment, an iterated fast-parallel architecture is used for modular polynomial multiplication.

For the product P(x) of two polynomials

A(x)=a[0]+a[1]x+a[2]x²+ . . . a[n−1]xⁿ⁻¹ (1)

B(x)=b[0]+b[1]x+b[2]x²+ . . . b[n−1]xⁿ⁻¹ (2)

over R_{q}, all the coefficients of P(x) need to be less than q but non-negative integers, while the degree of P(x) should be less than n, where R_{q}=Z_{q}/(xⁿ+1) is the ring of the polynomial, and Z_{q} is the ring of integers modulo a power-of-two integer q. The schoolbook polynomial multiplication between A(x) and B(x) modulo (xⁿ+1, q) can be described as

$$\begin{matrix}A ( x ) \cdot B ( x ) = {\sum }_{i = 0}^{n - 1} {\sum }_{j = 0}^{n - 1} a [ i ] b [ j ] {x}^{i + j} mod ( {x}^{n} + 1 , q ) \\ = {\sum }_{i = 0}^{n - 1} ( {\sum }_{j = 0}^{n - 1} {( - 1 )}^{⌊ ( i + j ) / n ⌋} a [ i ] b [ j ] mod q ) \cdot {x}^{( i + j ) mod n}\end{matrix} \qquad ( 3 )$$

To improve the efficiency and reduce the complexity of schoolbook polynomial multiplication, methods based on the divide-and-conquer strategy to increase the parallelism are of great interest. One of the examples is the Karatsuba algorithm. The 2-level Karatsuba polynomial multiplication first decomposes the input polynomials into higher-degree and lower-degree parts as A(x)=A₀(x)+A₁(x)·x^{n/2} and B(x)=B₀(x)+B₁(x)·x^{n/2} and computes

C₀(x)=A₀(x)·B₀(x)

C₁(x)=(A₀(x)+A₁(x))·(B₀(x)+B₁(x))

C₂(x)=A₁(x)·B₁(x) (4)

Then the above products are summed up and polynomial modular reduction is carried out to derive the product P(x) over the ring as

P(x)=C₀(x)+C₃(x)·x^{n/2}+C₂(x)·xⁿ mod(xⁿ+1) (5)

where

C₃(x)=(C₁(x)−C₀(x)−C₂(x)) (6)

Note that the degrees of C₃(x)·x^{n/2} and C₂(x)·xⁿ are

$$\frac{3}{2} n$$

and 2n, respectively. Hence polynomial subtractions are needed to perform the modular reduction by xⁿ+1. Based on this divide-and-conquer strategy of the Karatsuba algorithm, the number of coefficient multiplications is reduced from n² to 3(n/2)².

Consider the design for a degree-n modular polynomial multiplier described by Equation (3). In this section, we use n=4 as an example to illustrate our proposed novel modular polynomial multiplier. The modular polynomial multiplication is described by:

$$P ( x ) = A ( x ) \cdot B ( x ) mod ( {x}^{4} + 1 , q ) \qquad ( 7 )$$

$$= p [ 0 ] + p [ 1 ] x + p [ 2 ] {x}^{2} + p [ 3 ] {x}^{3}$$

$$where$$

$$A ( x ) = a [ 0 ] + a [ 1 ] x + a [ 2 ] {x}^{2} + a [ 3 ] {x}^{3}$$

$$B ( x ) = b [ 0 ] + b [ 1 ] x + b [ 2 ] {x}^{2} + b [ 3 ] {x}^{3}$$

The polynomial multiplication of A(x) and B(x) leads to

P′(x)=p′[0]+p′[1]x+p′[2]x²+p′[3]x³+p′[4]x⁴+p′[5]x⁵+p′[6]x⁶ (8)

Since the polynomial multiplication has a degree higher than three, the terms x⁴, x⁵, and x⁶ are replaced by −1, −x, and −x², respectively, to perform the modular reduction. Thus, the coefficients of the modular polynomial multiplication are:

p[3]=a[3]b[0]+a[2]b[1]+a[1]b[2]+a[0]b[3],

p[2]=a[2]b[0]+a[1]b[1]+a[0]b[2]−a[3]b[3],

p[1]=a[1]b[0]+a[0]b[1]−a[3]b[2]−a[2]b[3],

p[0]=a[0]b[0]−a[3]b[1]−a[2]b[2]−a[1]b[3]. (9)

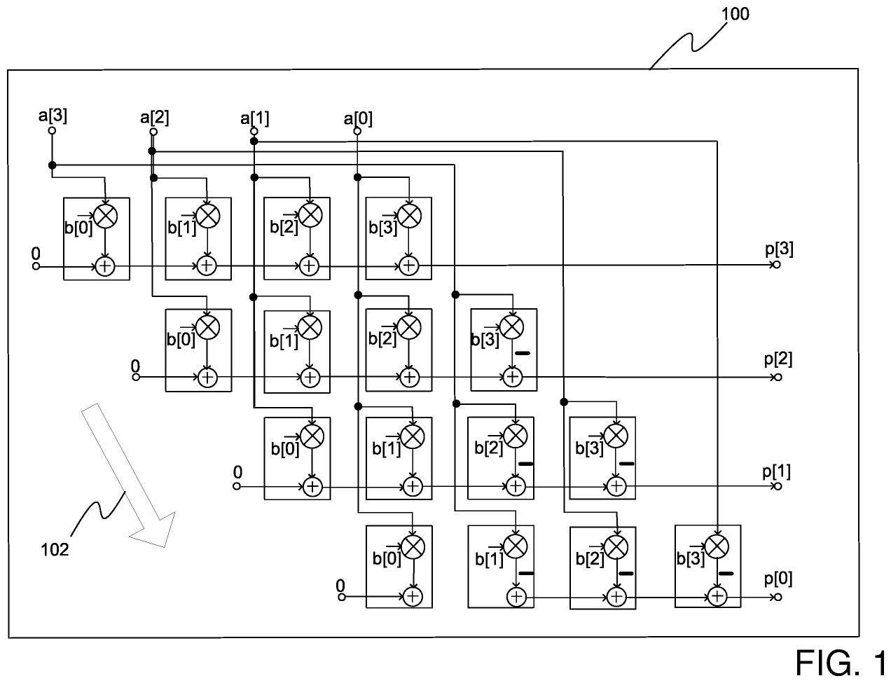

A dependence graph (DG) 100 of the modular polynomial multiplication for the n=4 example is shown in FIG. 1. Dependence graph 100 can be mapped to a weight-stationary systolic array using projection vector 102.

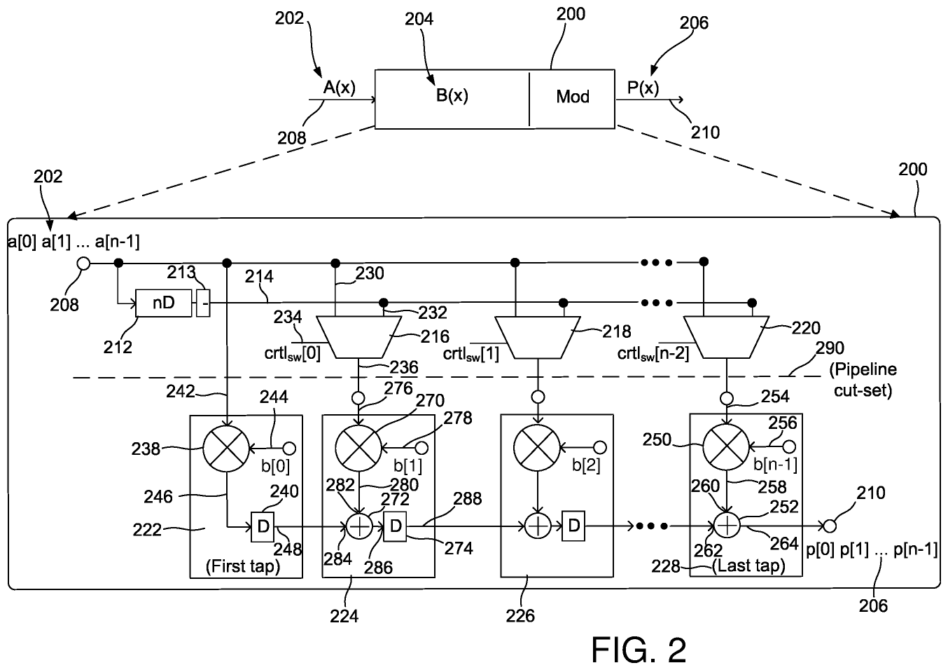

FIG. 2 shows an example modular polynomial multiplier 200 having a systolic architecture for a degree n. Modular polynomial multiplier 200 determines a modular polynomial product P(x) 206 from an input polynomial A(x) 202 and an input polynomial B(x) 204, all of degree n. Polynomial A(x) 202 is provided on an input line 208 as a series of coefficients. A new coefficient is provided with each clock cycle and the series starts with the most-significant coefficient (a[n−1], the coefficient for xⁿ) Each coefficient of polynomial B(x) 204 is provided to a respective one of a plurality of processing elements, discussed further below. Modular polynomial product P(x) 206 is provided on an output line 210 as a series of coefficients with a new coefficient provided with each clock cycle and the series starting with the most-significant coefficient (p[n−1], the coefficient for xⁿ). In this context, each clock cycle is the time needed to multiply two coefficients together and provide the product.

Modular polynomial multiplier 200 includes input line 208, shift register 212, negation unit 213, delay line 214, multiplexers, such as multiplexers 216, 218, and 220, processing elements, such as processing elements 222, 224, 226 and 228, and output line 210.

With each clock cycle, the current coefficient on input line 208 is loaded into shift register 212 and any coefficients previously loaded into shift register 212 are shifted one place. After n clock cycles, the oldest coefficient in shift register 212 is negated by negation unit 213 and is output onto delay line 214. With each subsequent clock cycle, another respective coefficient in shift register 212 is negated and output on delay line 214. Thus, for the first n clock cycles, the coefficients of A(x) appear on input line 208, one coefficient per clock cycle, in order from the most-significant coefficient (a[n−1]) to the least-significant coefficient (a[0]). For the next n clock cycles, the negatives of the coefficients of A(x) appear on delay line 214, one coefficient per clock cycle, in order from the most-significant coefficient (−a[n−1]) to the least-significant coefficient (−a[0]).

There are n−1 multiplexers. Each multiplexer has two inputs, a control line and an output. One input of each multiplexer is connected to input line 208 and the other input is connected to delay line 214. Each control line receives a respective control signal that causes the multiplexer to either connect input line 208 to the output of the multiplexer or connect delay line 214 to the output of the multiplexer. The output of each multiplexer is connected to a respective processing element. For example, multiplexer 216 has input 230 connected to input line 208, input 232 connected to delay line 214, control line 234 and output 236 connected to processing element 224.

There are n processing elements. Processing element 222, referred to as the first tap, includes a multiplication unit 238 and a delay unit 240. Multiplication unit 238 has two inputs 242 and 244 and an output 246. Input 242 is connected to input line 208 and input 242 receives the least-significant coefficient, b[0], of input polynomial B(x) 204. With each clock cycle, multiplication unit 238 multiplies the current value on input line 208 with coefficient b[0] and provides the product on output 246. Output 246 of multiplication unit 238 is connected to an input of delay unit 240. Delay unit 240 delays each value received from multiplication unit 238 by one clock cycle and outputs the delayed value on a processing element output 248.

Processing element 228, referred to as the last tap, includes a multiplication unit 250 and an addition unit 252. Multiplication unit 250 has two inputs 254 and 256 and an output 258. Input 254 is connected to the output of multiplexer 220 and input 256 receives the most-significant coefficient, b[n−1], of input polynomial B(x) 204. With each clock cycle, multiplication unit 250 multiplies the current value provided by multiplexer 220 with coefficient b[n−1] and provides the product on output 258. Output 258 of multiplication unit 250 is connected to an input 260 of addition unit 252, which also includes an input 262 and an output 264. Input 262 carries an accumulated sum produced by other processing elements as discussed further below. Addition unit 252 adds the value on input 260 to the value on input 262 and provides the sum on output 264. In accordance with one embodiment, addition unit 252 forms the sum in less than a clock cycle of modular polynomial multiplier 200. Output 264 of addition unit 252 forms output line 210 of modular polynomial multiplier 200.

Between first tap processing element 222 and last tap processing element 228, there are n−2 structurally identical processing elements, such as processing elements 224 and 226, connected in series. Since all of the n−2 processing elements are identical, the structure is described below with reference to just processing element 224. However, the description of processing element 224 is applicable to all of the structurally-identical processing elements.

Processing element 224 has a multiplication unit 270, an addition unit 272 and a delay unit 274. Multiplication unit 270 has two inputs 276 and 278 and an output 280. Input 276 is connected to the output of a respective multiplexer (in this case, output 236 of multiplexer 216) and input 278 receives a respective coefficient of input polynomial B(x) (in this case, coefficient b[1]). With each clock cycle, multiplication unit 270 multiplies the two coefficients on inputs 276 and 278 and provides the product on output 280. Addition unit 272 includes two inputs 282 and 284 and an output 286. Input 282 is connected to output 280 of multiplication unit 270 and input 284 is connected to the output of a delay unit of a respective preceding processing element (in this case output 248 of delay unit 240 of preceding processing element 222). Addition unit 272 adds the values on inputs 282 and 284 and provides the sum on output 286. Addition unit operates at less than a clock cycle so that the sum is provided within the same clock cycle that the product is provided on output 280 by multiplication unit 270. Output 286 is connected to delay unit 274, which delays the value on output 286 by one clock cycle and provides the delayed value on a processing element output 288.

For a value of n=4, modular polynomial multiplier 200 implements Equation 9 above. At a first clock cycle, a[3]b[0] is determined by multiplication unit 238. At the next clock cycle, a[2]b[1] is determined by multiplication unit 270 and a[3]b[0] is output by delay unit 240. Within this same clock cycle, addition unit 272 forms the sum a[3]b[0]+a[2]b[1]. During the next clock cycle, a[1]b[2] is determined by the multiplication unit of processing element 226, a[1]b[1] is determined by multiplication unit 270 and a[1]b[0] is determined by multiplication unit 238. Within this same clock cycle, the addition unit of processing element 226 forms the sum a[3]b[0]+a[2]b[1]+a[1]b[2], and addition unit 272 forms the sum a[2]b[0]+a[1]b[1].

During the next clock cycle, a[0]b[3] is determined by multiplication unit 250, a[0]b[2] is determined by the multiplication unit of processing element 226, a[0]b[1] is determined by multiplication unit 270 and a[0]b[0] is determined by multiplication unit 238. Within this same clock cycle, addition unit 252 forms the sum a[3]b[0]+a[2]b[1]+a[1]b[2]+a[0]b[3], the addition unit of processing element 226 forms the sum a[2]b[0]+a[1]b[1]+a[0]b[2], and addition unit 272 forms the sum a[1]b[0]+a[0]b[1]. As shown in Equation 9, the sum produced by addition unit 252 represents p[3].

At the next clock cycle, the control signal to the multiplexers causes all of the multiplexers to switch from connecting input line 208 to the processing elements to connecting delay line 214 to the processing elements. As a result, during this clock cycle −a[3] is input to each processing element after processing element 222 and −a[3]b[3] is determined by multiplication unit 250, −a[3]b[2] is determined by the multiplication unit of processing element 226, and −a[3]b[1] is determined by multiplication unit 270. Within this same clock cycle, addition unit 252 forms the sum a[2]b[0]+a[1]b[1]+a[0]b[2]−a[3]b[3], the addition unit of processing element 226 forms the sum a[1]b[0]+a[0]b[1]−a[3]b[2], and addition unit 272 forms the sum a[0]b[0]−a[3]b[1]. As shown in Equation 9, the sum produced by addition unit 252 represents p[2].

During the next clock cycle −a[2] is input to each processing element after processing element 222 and −a[2]b[3] is determined by multiplication unit 250, and −a[2]b[2] is determined by the multiplication unit of processing element 226. Within this same clock cycle, addition unit 252 forms the sum a[1]b[0]+a[0]b[1]−a[3]b[2]−a[2]b[3], and the addition unit of processing element 226 forms the sum a[0]b[0]−a[3]b[1]−a[2]b[2]. As shown in Equation 9, the sum produced by addition unit 252 represents p[1].

During the next clock cycle −a[1] is input to each processing element after processing element 222 and −a[1]b[3] is determined by multiplication unit 250. Within this same clock cycle, addition unit 252 forms the sum a[0]b[0]−a[3]b[1]−a[2]b[2]−a[1]b[3]. As shown in Equation 9, the sum produced by addition unit 252 represents p[0].

In the description above, the coefficients provided on output line 210 are surrounded by random values. In other embodiments, the coefficients on output line 210 can be surrounded by zeros by adding n zeros before the coefficients of A(x), n zeros after the coefficients of A(x) and controlling the multiplexers so that they output a value of zero for the values that surround the product coefficients. Using this technique, when a[n−1] appears on input line 208, delay line 214 carries a zero. Thus, during this clock cycle, all of the multiplexers connect delay line 214 to the processing elements so each of the processing elements other than processing element 222 receives a value of zero. With the next clock cycle, multiplexer 216 connects processing element 224 to input line 208 so that processing elements 222 and 224 receive a[n−2] while the remaining processing elements remain connected to delay line 214 and thus receive a value of zero. This progression continues until all of the processing elements are connected to input line 208. At the next clock cycle, each multiplexer other than multiplexer 216, is switched so that the output of the multiplexer is connected to delay line 214. As a result, each of the switched multiplexers provide −a[n] at their output while multiplication units 238 and 270 receive a value of zero from input line 208. With each clock cycle thereafter, an additional multiplexer is switched to connect its output to input line 208 until all of the multiplexer outputs are connected to input line 208.

Taken together, FIG. 2 shows that a degree-n modular polynomial multiplier requires n modular multipliers, (n−1) modular adders, (n−1) delay elements, (n−1) multiplexers and one shift register (consisting of n delay elements) and one negation unit. For one modular polynomial multiplication, the response time is n clock cycles, while the total latency is (2n−1) clock cycles. For L polynomial multiplications, the response time remains the same, while the total latency in clock cycles is given by:

Tₗₐₜ=n·(L+1)−1 (10)

The modular reduction can be performed by simply keeping the least ϵ bits for a 2^{ϵ} modulus. For the lattice-based cryptography schemes, the degrees of the polynomial are relatively large, i.e., n can be up to hundreds or thousands, which could cause a high fan-out issue on the output of the shift register and the input node. To overcome this, buffers (registers) are inserted after the multiplexers, shown as dashed line 290 in FIG. 2. As a result, the critical path is one modular multiplier and one modular adder.

In accordance with some embodiments, modular polynomial multiplier 200 is used to construct a highly parallel modular polynomial multiplier that is based on a fast parallel filter algorithm. These embodiments have a significantly lower addition cost in the post-processing stage than the Karatsuba algorithm. Furthermore, these embodiments require less resource overhead than prior schoolbook polynomial multipliers.

### Fast 2-Parallel Architecture

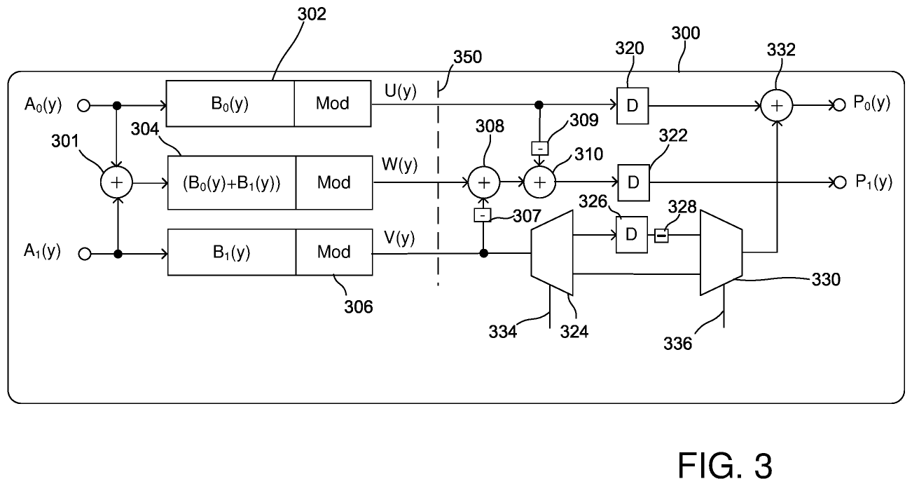

One example of a fast parallel modular polynomial multiplier is the fast 2-parallel modular polynomial multiplier 300 shown in FIG. 3, which implements Algorithm 1 below.

Algorithm 1 Fast.2.PolyMult(A(x), B(x))

Input: A(x) and B(x) ∈ R_{q}
Output: P(x)=(P₀(x² ),P₁(x² ))
//P(x)=A(x)·B(x) mod (xⁿ+1,q)

```
1: A(x)+A₀(x² )+A₁(x² )·x
  //split A(x) as two parts based odd and even indices
  B(x)=B₀(x² )+B₁(x² )·x
  //split B(x) as two parts based odd and even indices
2: U(y)=A₀(y)B₀(y) mod (y^{n/2}+1,q), where y=x²
  //intermediate polynomial multiplication
  V(y)=A₁(y)B₁(y) mod (y^{n/2}+1,q)
  W(y)=(A₀(y)+A₁(y))(B₀(y)+B₁(y))
```

mod (y^{n/2} +1,q)

3: P₀(y)=U(y)+V(y)·y mod (y^{n/2}+1,q)
P₁(y)=W(y)−(U(y)+V(y)) mod (y^{n/2+}1,q)
4: P(x)=P₀(x² )+P₁(x² )·x, where y=x²
5: return P(x)

In a pre-processing step (step 1), input polynomials A(x) and B(x) are decomposed based on the even and odd indices (also called polyphaser decomposition). With y=x², the polynomial A(x) is expressed as:

A(x)=A₀(x²)+A₁(x²)·x=A₀(y)+A₁(y)·x (11)

where the even indexed polynomial A₀(y) and the odd indexed polynomial A₁(y) are expressed as:

A₀(y)=a[0]+a[2]y+a[4]y²+ . . . +a[n−2]yⁿ^{_{/2−1}} mod(yⁿ^{_{/2}}+1) (12)

A₁(y)=a[1]+a[3]y+a[5]y²+ . . . +a[n−1]yⁿ^{_{/2−1}} mod(yⁿ^{_{/2}}+1) (13)

Similar decomposition is applied to B(x) to obtain its even and odd polynomials B₀(y) and B₁(y). The coefficients of the even and odd polynomials of each respective power are then summed by an adder 301 to form (A₀(y)+A₁(y)) and by an adder (not shown) to form (B₀(y)+B₁(y)).

The product P(x) can be computed as:

$$P ( x ) = {P}_{0} ( y ) + {P}_{1} ( y ) \cdot x \qquad ( 14 )$$

$$= ( {A}_{0} ( y ) + {A}_{1} ( y ) \cdot x ) \cdot ( {B}_{0} ( y ) + {B}_{1} ( y ) \cdot x )$$

$$= {A}_{0} ( y ) {B}_{0} ( y ) + [ {A}_{0} ( y ) {B}_{1} ( y ) + {A}_{1} ( y ) {B}_{0} ( y ) ] \cdot x + [ {A}_{1} ( y ) {B}_{1} ( y ) ] \cdot y$$

The polyphase decomposition describes one polynomial multiplication of length-n in terms of four polynomial multiplications of length-n/2. While this step in itself does not reduce the computation complexity, it is an essential first step.

In Step 2 of algorithm 1, modular polynomial multiplier 300 uses three modular polynomial multipliers 302, 304 and 306 to perform three modular multiplications in parallel. In accordance with one embodiment, each of modular polynomial multipliers 302, 304 and 306 is structurally identical to systolic modular polynomial multiplier 200 of FIG. 2. The three polynomial multiplications are half the length of polynomials A(x) and B(x) thereby reducing the complexity by 25%.

Modular polynomial multiplier 302 determines the modular product of A₀(y)B₀(y), referred to as U(y); modular polynomial multiplier 304 determines the modular product of (A₀(y)+A₁(y))(B₀(y)+B₁(y)), referred to as W(y); and modular polynomial multiplier 306 determines the modular product of A₁(y)B₁(y), referred to as V(y).

P₁(y) of the product P(x) is computed as:

$${P}_{1} ( y ) = {A}_{0} ( y ) {B}_{1} ( y ) + {A}_{1} ( y ) {B}_{0} ( y ) \qquad ( 15 )$$

$$= ( {A}_{0} ( y ) + {A}_{1} ( y ) ) ( {B}_{0} ( y ) + {B}_{1} ( y ) ) - {A}_{0} ( y ) {B}_{0} ( y ) - {A}_{1} ( y ) {B}_{1} ( y )$$

$$= W ( y ) - ( U ( y ) + V ( y ) ) \qquad ( 16 )$$

$$where$$

$$U ( y ) = {A}_{0} ( y ) {B}_{0} ( y ) \qquad ( 17 )$$

$$V ( y ) = {A}_{1} ( y ) {B}_{1} ( y ) \qquad ( 18 )$$

$$W ( y ) = ( {A}_{0} ( y ) + {A}_{1} ( y ) ) ( {B}_{0} ( y ) + {B}_{1} ( y ) ) \qquad ( 19 )$$

Thus, P₁(y) can be determined by subtracting the output of modular polynomial multipliers 302 and 306 (U(y), V(y)) from the output of modular polynomial multiplier 304 (W(y)). These subtractions are performed by negation units 307 and 309 and addition units 308 and 310 in FIG. 3.

P₀(y) of the product P(x) is computed as:

$${P}_{0} ( y ) = [ {A}_{0} ( y ) {B}_{0} ( y ) + [ {A}_{1} ( y ) {B}_{1} ( y ) ] \cdot y ] mod ( {y}^{n / 2} + 1 ) \qquad ( 20 )$$

$$= [ U ( y ) + V ( y ) \cdot y ] mod ( {y}^{n / 2} + 1 )$$

Since V(y) needs to be multiplied by y before adding the coefficients of U(y), the highest degree of coefficient exceeds the range of the ring (yⁿ^{_{/2}}+1), (i. e., U(y)+V(y)·y=u[0]+p₀[1]y+p₀[2]y²+ . . . +v[n/₂−1]yⁿ^{_{/2}} where each p₀[i] is the sum of all coefficient products for power (y) As a result, to enforce the modulo constraints, the even polynomial P₀(y) requires an additional subtraction and is computed as:

P₀(y)=(u[0]−v[n/₂−1])+p₀[1]y+p₀[2]y²+ . . . +p₀[n/₂−1]yⁿ^{_{/2}}⁻¹ (21)

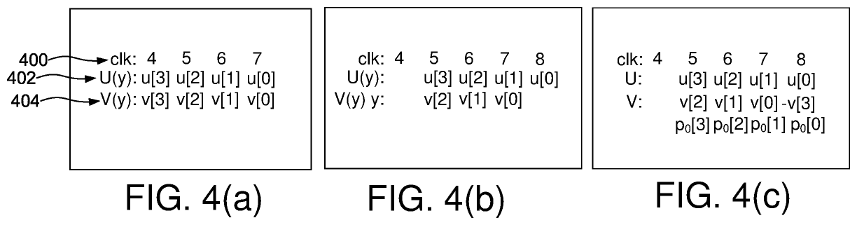

In accordance with one embodiment, the summation of Equation 21 is achieved using multiplexers and delays and is explained using the timing diagrams for n=8 shown in FIGS. 4(a), 4(b) and 4(c). As noted above, U(y) and V(y) are determined in parallel such that the most-significant coefficient of each polynomial is output by modular polynomial multipliers 302 and 306 during the same clock cycle. Thus, the coefficients of U(y) and V (y) are generated in the pattern as shown in the table of FIG. 4(a), where indexes for clock cycles are shown in top row 400, the coefficients produced for U(y) at each clock cycle are shown in row 402 and the coefficients produced for V(y) at each clock cycle are shown in row 404.

In order to implement the multiplication of V(y) by y, the embodiments delay U(y) by one clock cycle. This aligns the coefficient for y^{x} in U(y) with the coefficient for y^{x-1} in V(y) as shown in FIG. 4(b), which is equivalent to multiplying V(y) by y. This delay is implemented in modular polynomial multiplier 300 of FIG. 3 by a delay unit 320 connected to the output of modular polynomial multiplier 302. Because delay unit 320 delays P₀(y) by one clock cycle, a delay unit 322 is added to P₁(y) to maintain the timing between P₀(y) and P₁(y).

The modular reduction is performed by delaying the most-significant coefficient, v[n/2−1], by n/2 clock cycles and then subtracting the delayed value from u[0] as shown in FIG. 4(c). Note that n/2 is equal to the number of coefficients in V(y). To implement this modular reduction, modular polynomial multiplier 300 uses an addition unit 332 and a delay circuit that includes a demultiplexer 324 (also referred to as a switch), a delay unit 326, a negation unit 328, and a multiplexer 330 (also referred to as a switch). When v[n/2−1] appears on the output of modular polynomial multiplier 306, a control signal 334 causes demultiplexer 324 to connect the output of modular polynomial multiplier 306 to the input of delay unit 326, which stores v[n/2−1]. At the next clock cycle, control signal 334 to demultiplexer 324 and control signal 336 to multiplexer 330 cause demultiplexer 324 and multiplexer 330 to connect the output of modular polynomial multiplier 306 to an input of addition unit 332. As a result, for the next n/2−1 clock cycles, the coefficients of V(y) are provided to one input of addition unit 332. The other input of addition unit 332 is connected to the output of delay unit 320 and thus receives the coefficients of U(y) delayed by one clock cycle. As a result, addition unit 332 determines the following sums u[n/2−1]+v[n/2−2], u[n/2−1]+v[n/2−3], . . . , u[1]+v[0].

After n/2 clock cycles, control signal 336 causes multiplexer 330 to connect the output of negation unit 328 to addition unit 332. As a result, v[n/2−1], which is held in delay unit 326, is negated by negation unit 328 and is applied to the input of addition unit 332. Addition unit 332 then adds the negative of v[n/2−1] to u[0] to provide the last coefficient of P₀(y).

Note that no additional adder/subtractor is needed and full hardware utilization is retained for all the components in the circuit. Moreover, this optimization technique still allows continuous processing of modular polynomial multiplications without requiring any null operations.

In accordance with some embodiments, registers are added along dashed line 350 to reduce the critical path of modular polynomial multiplier 300.

The computation V(y)·y is inherently a non-causal operation. This is transformed to a causal operation by introducing delay unit 320. This does not increase the latency beyond one clock cycle and preserves the feed-forward property of the architecture and continuous data-flow property.

Different from the traditional methods that execute the polynomial modular reduction during or after post-processing (i.e., combining the intermediate polynomials back to a single polynomial), the embodiments integrate polynomial modular reduction into the three intermediate polynomial multiplications. This is achieved by using the sequential systolic modular polynomial multiplication described in FIG. 2. A 2-level Karatsuba polynomial multiplication requires at least (n−1) clock cycles to output n coefficients sequentially for the three intermediate polynomials and

$$( \frac{7}{2} n - 4 )$$

or (3n−3) modular additions/subtractions for post-processing. In contrast, by employing the sequential weight-stationary systolic polynomial modular multiplier as shown in FIG. 2, n/2 coefficients of U(y), V (y), and W(y) are output in the same (n−1) clock cycles without requiring additional elements. As these three intermediate polynomials are already in the ring R_{q}, the post-processing stage has a lower cost, which only needs

$$\frac{3}{2} n$$

modular additions/subtractions.

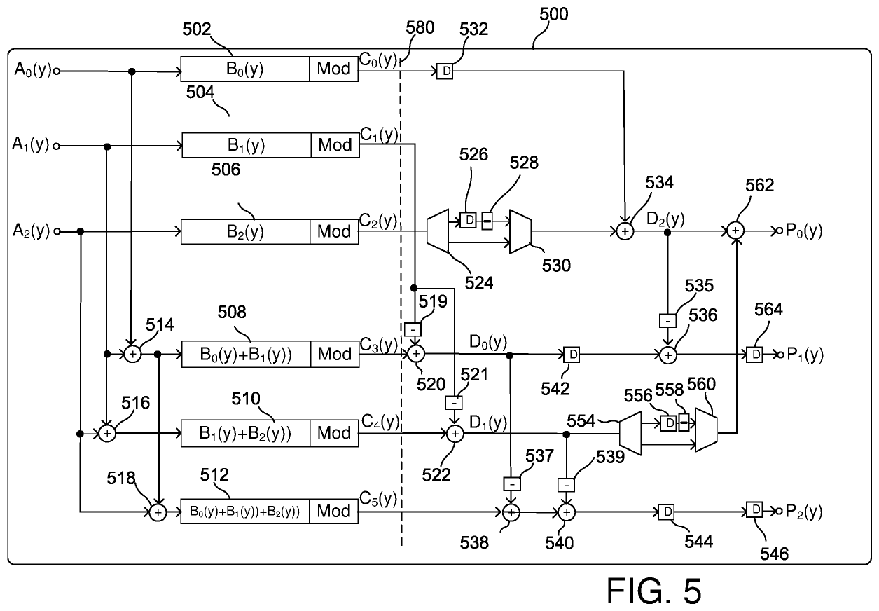

In the fast 2-parallel modular polynomial multiplier discussed above, the input polynomials and the output polynomial are decomposed into two phases. The invention is not limited to two phases and can be implemented using any number of phases. For example, FIG. 5 provides a fast 3-parallel modular polynomial multiplier 500, which implements Algorithm 2 below.

Algorithm 2 Fast.3.PolyMult(A(x), B(x))

Input: A(x) and B(x) ∈ R_{q}
Output: P(x)=(P₀(x³ ),P₁(x³ ),P₂(x³ ))
//P(x)=A(x)·B(x) mod (xⁿ+1,q)

```
1: A(x)+A₀(x³ )+A₁(x³ )·x+A₂(x³ )·x²
  B(x)=B₀(x³ )+B₁(x³ )·x+B₂(x³ )·x²
2: C₀(y)=A₀(y)B₀(y) mod (y^{n/3}+1,q)
  C₁(y)=A₁(y)B₁(y) mod (y^{n/3}+1,q)
  C₂(y)=A₂(y)B₂(y) mod (y^{n/3}+1,q)
  C₃(y)=(A₀(y)+A₁(y))(B₀(y)+B₁(y))mod (y^{n/3}+1,q)
  C₄(y)=(A₁(y)+A₂(y))(B₁(y)+B₂(y))mod (y^{n/3}+1,q)
  C₅(y)=(A₀(y)+A₁(y)+A₂(y))(B₀(y)+B₁(y)+B₂(y)) mod (y^{n/3}+1,q), where y=x³
3: D₀(y)=C₃(y)−C₁(y) mod (y^{n/3}+1,q)
  D₁(y)=C₄(y)−C₁(y) mod (y^{n/3}+1,q)
  D₂(y)= C₀(y)−C₂(y)·y mod (y^{n/3}+1,q)
4: P₀(y)=D₂(y)+D₁(y)·y mod (y^{n/3}+1,q)
P₁(y)=D₀(y)−D₂(y) mod (y^{n/3}+1,q)
P₂(y)=C₅(y)−D₀(y)−D₁(y) mod (y^{n/3}+1,q)
5: P(x)=P₀(x³ )+P₁(x³ )·x+P₂(x³ )·x², where y=x³
6: return P(x)
```

During the polyphase decomposition (step 1), polynomials A(x) and B(x) are decomposed as

A(x)=A₀(y)+A₁(y)·x+A₂(y)·x².

B(x)=B₀(y)+B₁(y)·x+B₂(y)·x². (22)

The modular multiplication result P(x) is also decomposed as:

P(x)=P₀(y)+P₁(y)·x+P₂(y)·x², (23)

where y=x³.

Fast 3-parallel modular polynomial multiplier 500 includes six modular polynomial multipliers 502, 504, 506, 508, 510 and 512 that operate in parallel with each other and that each perform a modulo (y^{n/3}+1) multiplication of two respective polynomials of length n/3. In accordance with one embodiment, each of modular polynomial multipliers 502, 504, 506, 508, 510 and 512 are structurally identical to modular polynomial multiplier 200.

In step 2 of algorithm 2, multiplier 502 determines the modular polynomial product C₀(y) of A₀(y)B₀(y); multiplier 504 determines the modular polynomial product C₁(y) of A₁(y)B₁(y); multiplier 506 determines the modular polynomial product C₂(y) of A₂(y)B₂(y); multiplier 508 determines the modular polynomial product C₃(y) of (A₀(y)+A₁(y))(B₀(y)+B₁(y)) where (A₀(y)+A₁(y)) is produced by addition unit 514 and (B₀(y)+B₁(y)) is determined by another addition unit (not shown); multiplier 510 determines the modular polynomial product C₄(y) of (A₁(y)+A₂(y))(B₁(y)+B₂(y)) where (A₁(y)+A₂(y)) is produced by addition unit 516 and (B₁(y)+B₂(y)) is determined by another addition unit (not shown); and multiplier 512 determines the modular polynomial product C₅(y) of (A₀(y)+A₁(y))+A₂(y))(B₀(y)+B₁(y))+B₂(y)) where (A₀(y)+A₁(y)+A₂(y)) is produced by addition unit 518 and (B₀(y)+B₁(y))+B₂(y)) is determined by another addition unit (not shown).

In step 3, negation unit 519 and addition unit 520 determine D₀(y)=C₃(y)+(−C₁(y)) and negation unit 521 and addition unit 522 determine D₁(y)=C₄(y)+(−C₁(y)). In addition, an addition unit 534, a delay unit 532, and a delay circuit that includes demultiplexer 524 (also referred to as a switch), delay unit 526, negation unit 528, and multiplexer 530 (also referred to as a switch) determine D₂(y)=C₀(y)−C₂(y)·y mod (y^{n/3}+1,q). The modular reduction is performed by delaying the most-significant coefficient, c₂[n/3 −1], by n/3 clock cycles and then subtracting the delayed value from c₀[0]. Note that n/3 is equal to the number of coefficients in C₂(y). When c₂[n/3 −1] appears on the output of modular polynomial multiplier 506, a control signal causes demultiplexer 524 to connect the output of modular polynomial multiplier 506 to the input of delay unit 526, which stores c₂[n/3 −1]. At the next clock cycle, the control signal to demultiplexer 524 and a control signal to multiplexer 530 cause demultiplexer 524 and multiplexer 530 to connect the output of modular polynomial multiplier 506 to an input of addition unit 534. As a result, for the next n/3 −1 clock cycles, the coefficients of C₂(y) are provided to one input of addition unit 534. The other input of addition unit 534 is connected to the output of delay unit 532 and thus receives the coefficients of C₀(y) delayed by one clock cycle. As a result, addition unit 534 determines the following sums C₂[n/3 −1]+C₀[n/3 −2], C₂[n/3−2]+C₀[n/3 −3], . . . , C₂[1]+C₀[0]. After n/3 clock cycles, the control signal causes multiplexer 530 to connect the output of negation unit 528 to addition unit 534. As a result, c₂[n/3 −1], which is held in delay unit 526, is negated by negation unit 528 and is applied to the input of addition unit 534. Addition unit 534 then adds the negative of c₂[n/3 −1] to c₀[0] to provide the last coefficient of D₂(y).

In step 4, negation unit 535 and addition unit 536 determine P₁(y)=D₀(y)+(−D₂(y)) and negation units 537 and 539 and addition units 538 and 540 determine P₂(y)=C₅(y)+(−D₀(y))+(−D₁(y)). In order to align D₂(y) with D₀(y) before the addition, a delay unit 542 delays D₀(y) by one clock cycle. In addition, an addition unit 562 and a delay circuit that includes a demultiplexer 554 (also referred to as a switch), a delay unit 556, a negation unit 558, and a multiplexer 560 (also referred to as a switch), determine P₀(y)=D₂(y)+D₁(y)·y mod (y^{n/3}+1,q). The modular reduction is performed by delaying the most-significant coefficient, d₁[n/3 −1], by n/3 clock cycles and then subtracting the delayed value from d₁[0]. Note that n/3 is equal to the number of coefficients in D₂(y). When d₁[n/3 −1] appears on the output of addition unit 522, a control signal causes demultiplexer 554 to connect the output of addition unit 522 to the input of delay unit 556, which stores d₁[n/3 −1]. At the next clock cycle, the control signal to demultiplexer 554 and a control signal to multiplexer 560 cause demultiplexer 554 and multiplexer 560 to connect the output of addition unit 522 to an input of addition unit 562. As a result, for the next n/3 −1 clock cycles, the coefficients of D₁(y) are provided to one input of addition unit 562. The other input of addition unit 562 is connected to the output of addition unit 534 and thus receives the coefficients of D₂(y). As a result, addition unit 562 determines the following sums D₁[n/3 −1]+D₂[n/3 −2], D₁[n/3 −2]+D₂[n/3 −3], . . . , D₁[1]+D₂[0]. After n/3 clock cycles, the control signal causes multiplexer 560 to connect the output of negation unit 558 to addition unit 562. As a result, d₁[n/3 −1], which is held in delay unit 556, is negated by negation unit 558 and is applied to the input of addition unit 562. Addition unit 562 then adds the negative of d₁[n/3 −1] to d₂[0] to provide the last coefficient of P₀(y). To align P₂(y) with P₀(y), P₂(y) passes through two delay units 544 and 546. To align P₁(y) with P₀(y), P₁(y) passes through delay unit 564.

In accordance with one embodiment, registers are added at the modular polynomial multiplier's outputs as shown by dashed line 580 to shorten the critical path of the system.

The fast 2-parallel architecture and/or fast 3-parallel architecture can be iterated to achieve higher levels of parallelism. Therefore, we can implement various fast M-parallel architectures, where the level of parallelism M can be a power-of-two integer, power-of-three integer, or product of any power-of-two and power-of-three. Note that the coefficients from all the sub-polynomials of P(x) should be aligned after all operations. This is similar to inserting a pipelining cutset to transform non-causal operations to causal operations, at the expense of an increase in latency by one cycle.

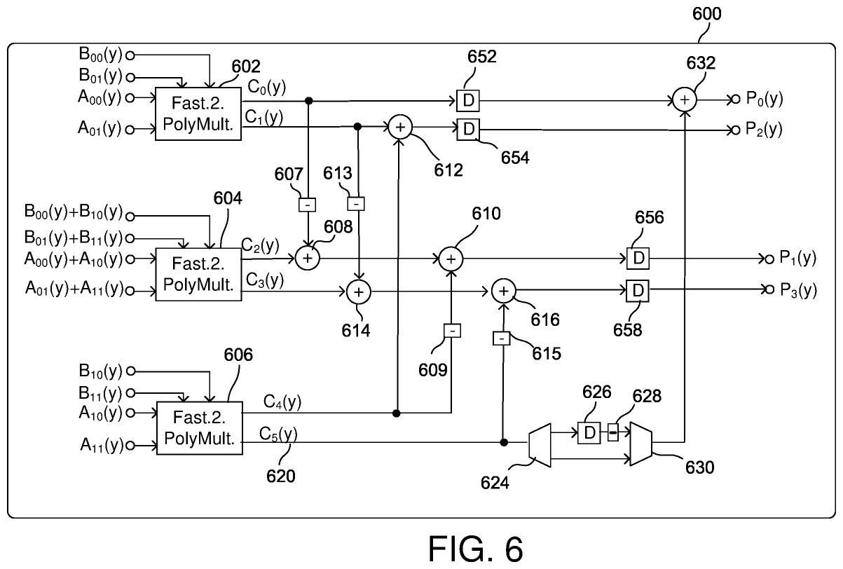

For example, FIG. 6 provides a fast 4-parallel modular polynomial multiplier 600 that is derived by iterating the fast 2-parallel modular polynomial multiplier twice. Fast 4-parallel modular polynomial multiplier 600 implements Algorithm 3 below.

Algorithm 3 Fast.4.PolyMult(A(x), B(x))

Input: A(x) and B(x) ∈ R_{q}
Output: P(x)=(P₀(x⁴ ),P₁(x⁴ ),P₂(x⁴ ), P₃(x⁴ ))
//P(x)=A(x)·B(x) mod (xⁿ+1,q)

```
1: A(x)=A₀(x² )+A₁(x² )·x²
  //split A(x) as two parts based odd and even indices
  B(x)=B₀(x² )+B₁(x² )·x²
  //split B(x) as two parts based odd and even indices
2: A₀(x² )=A₀₀(x⁴ )+A₀₁(x⁴ )·x⁴
  A₁(x² )=A₁₀(x⁴ )+A₁₁(x⁴ )·x⁴
//split A₀(x² ) and A₁(x² ) as two parts based odd and even indices
  B₀(x² )=B₀₀(x⁴ )+B₀₁(x⁴)·x⁴
  B₁(x² )=B₁₀(x⁴ )+B₁₁(x⁴ )·x⁴
//split B₀(x² ) and B₁(x² ) as two parts based odd and even indices
  (A₀(x² )+ A₁(x² ))=(A₀₀(x⁴ )+A₁₀(x⁴ ))+(A₀₁(x⁴)+A₁₁(x⁴ ))·x⁴
  (B₀(x² )+ B₁(x² ))=(B₀₀(x⁴ )+ B₁₀(x⁴ ))+(B₀₁(x⁴ )+B₁₁(x⁴ ))·x⁴
  //group sum components to facilitate fast 2-parallel modular multiplication
3: (C₀(y), (C₁(y))=Fast.2.PolyMult (A₀(x²), B₀(x²)),
  where y=x⁴
  (C₂(y), C₃(y))=Fast.2.PolyMult ((A₀(x² )+A₁(x² )),
  (B₀(x² )+B₁(x² )))
  (C₄(y), C₅(y)=Fast.2.PolyMult (A₁(x² ), B₁(x² ))
3: P₀(y)=C₀(y)+C₅(y)·y mod (y^{n/4}+1,q)
  P₁(y)=C₂(y)−C₂(y)−C₄(y) mod (y^{n/4} +1,q)
  P₂(y)= C₁(y)+C₄(y) mod (y^{n/4}+1,q)
  P₃(y)= C₃(y)−C₁(y)−C₅(y) mod (y^{n/4} +1,q)
4: P(x)=P₀(x⁴ )⁺P₁(x⁴ )·x+ P₂(x⁴)·x²+P₃(x⁴)·x³,
where y=x
5: return P(x)
```

In Step 1 of Algorithm 3, A(x) and B(x) are each split as two parts, referred to as portions or sub-polynomials, based on the odd and even indices as part of the first iteration of the fast 2-parallel modular polynomial multiplier. This results in:

A(x)=A₀(x²)+A₁(x²)·x²

B(x)=B₀(x²)+B₁(x²)·x²

In the fast 2-parallel modular multiplier, the sub-polynomials formed through this decomposition and their sums were applied to three modular polynomial multipliers that were structurally identical to the modular multiplier of FIG. 2. In the fast 4-parallel modular polynomial, the sub-polynomials and their sums are instead applied in parallel to three fast 2-parallel modular multipliers 602, 604, and 606 that are structurally identical to each other and to fast 2-parallel modular polynomial multiplier 300 of FIG. 3.

The first step of applying the sub-polynomials and their sums to each fast 2-parallel modular multiplier is to decompose each sub-polynomial into sub-sub-polynomials (also referred to as sub-polynomials of portions of polynomials). For fast 2-parallel modular multiplier 602, this involves the following decompositions:

A₀(x²)=A₀₀(x⁴)+A₀₁(x⁴)·x⁴

B₀(x²)=B₀₀(x⁴)+B₀₁(x⁴)·x⁴

For fast 2-parallel modular multiplier 606 this involves the following decompositions:

A₁(x²)=A₁₀(x⁴)+A₁₁(x⁴)·x⁴

B₁(x²)=B₁₀(x⁴)+B₁₁(x⁴)·x⁴

For fast 2-parallel modular multiplier 604 this involves the following decompositions:

(A₀(x²)+A₁(x²))=(A₀₀(x⁴)+A₁₀(x⁴))+(A₀₁(x⁴)+A₁₁(x⁴))x⁴

(B₀(x²)+B₁(x²))=(B₀₀(x⁴)+B₁₀(x⁴))+(B₀₁(x⁴)+B₁₁(x⁴))x⁴

These decompositions result in the coefficients a[ ] and b[ ] of A(x) and B(x) being assigned to each sub-sub-polynomial as:

A₀₀(y)=a[0]+a[4]y+a[8]y²+ . . . +a[n−4]y^{n/4-1},

A₁₀(y)=a[1]+a[5]y+a[9]y²+ . . . +a[n−3]y^{n/4-1}

A₀₁(y)=a[2]+a[6]y+a[10]y²+ . . . +a[n−2]y^{n/4-1}

A₁₁(y)=a[3]+a[7]y+a[11]y²+ . . . +a[n−1]y^{n/4-1}

where

A(x)=A₀₀(y)+A₁₀(y)x+A₀₁(y)x²+A₁₁(y)x³.

B₀₀(y)=b[0]+b[4]y+b[8]y²+ . . . +b[n−4]y^{n/4-1},

B₁₀(y)=b[1]+b[5]y+b[9]y²+ . . . +b[n−3]y^{n/4-1}

B₀₁(y)=b[2]+b[6]y+b[10]y²+ . . . +b[n−2]y^{n/4-1}

B₁₁(y)=b[3]+b[7]y+b[11]y²+ . . . +b[n−1]y^{n/4-1}

where

B(x)=B₀₀(y)+B₁₀(y)x+B₀₁(y)x²+B₁₁(y)x³

and y=x⁴.

At step 3, the three fast 2-parallel modular multipliers 602, 604 and 606, also referred to as circuits, execute in parallel resulting in sub-sub-polynomials of the product. In particular, fast 2-parallel modular multiplier 602 produces sub-sub-polynomials C₀(y) and C₁(y), fast 2-parallel modular multiplier 604 produces sub-sub-polynomials C₂(y) and C₃(y), fast 2-parallel modular multiplier 606 produces sub-sub-polynomials C₄(y) and C₅(y).

As shown in FIG. 2, each of the fast 2-parallel modular multipliers 602, 604, and 606 consist of three systolic modular polynomial multipliers (also referred to as sub-circuits). In accordance with one embodiment, all of the systolic modular polynomial multipliers in fast 4-parallel modular multiplier 600 are structurally identical with each other.

At step 4, post processing is performed to form the sub-polynomials of the product: P₀(y), P₁(y), P₂(y), and P₃(y). P₁(y)=C₂(y)−C₀(y)−C₄(y) and is produced using negation units 607 and 609 and addition units 608 and 610. P₂(y)=C₁(y)+C₄(y) and is produced using addition unit 612. P₃(y)=C₃(y)−C₁(y)−C₅(y) and is produced using negation units 613 and 615 and addition units 614 and 616.

Sub-polynomial P₀(y) requires a modular reduction. The modular reduction is performed by delaying the most-significant coefficient, C₅[n/4-1], by n/4 clock cycles and then subtracting the delayed value from c₀[0]. Note that n/4 is equal to the number of coefficients in C₅(y). To implement this modular reduction, fast 4-parallel modular polynomial multiplier 600 uses an addition unit 632 and a delay circuit that includes a demultiplexer 624 (also referred to as a switch), a delay unit 626, a negation unit 628, a multiplexer 630 (also referred to as a switch). When C₅[n/4-1], appears on the output of fast 2-parallel modular polynomial multiplier 606, a control signal causes demultiplexer 624 to connect output 620 of modular polynomial multiplier 606 to the input of delay unit 626, which stores C₅[n/4-1], At the next clock cycle, the control signal to demultiplexer 624 and a control signal to multiplexer 630 cause demultiplexer 624 and 630 to connect the output of fast 2-parallel modular polynomial multiplier 606 to an input of addition unit 632. As a result, for the next n/4-1 clock cycles, the coefficients of C₅(y) are provided to one input of addition unit 632. The other input of addition unit 632 is connected to the output of a delay unit 652 and thus receives the coefficients of C₀(y) delayed by one clock cycle. As a result, addition unit 632 determines the following sums C₀[n/4-1]+C₅[n/4-2], C₀[n/4-2]+C₅[n/4-3], . . . , C₀[1]+C₅[0].

After n/4 clock cycles, the control signal causes multiplexer 630 to connect the output of negation unit 628 to addition unit 632. As a result, C₅[n/4-1], which is held in delay unit 626, is negated by negation unit 628 and is applied to the input of addition unit 632. Addition unit 632 then adds the negative of C₅[n/4-1] to C₀[0] to provide the last coefficient of P₀(y).

Delay units 654, 656 and 658 are used to align P₂(y), P₁(y), and P₃(y), respectively, with P₀(y).

The timing performance can be theoretically derived as follows. The fast M-parallel design can reduce the response time to approximately n/M clock cycles. In general, the total latency of an M-parallel modular polynomial multiplier for L polynomial multiplications can be expressed as:

Tₗₐₜ=n(1+L)/M+┌log₂(M)┐. (24)

The performance of the embodiments described above was evaluated for the Saber scheme using Verilog HDL implementation. Several changes are adopted specifically for the Saber scheme. Due to the Saber scheme's advantages, the basic components do not consume a large amount of hardware resources. In particular, the modular multiplier discussed above can be replaced by general adders since the random elements are small (since the coefficients of polynomial B(x) are in [−4, 4]). As the moduli are power-of-two integers, the modular reduction can again be performed by simply keeping the lower bits. Note that, the coefficients in both polynomials A(x) and B(x) are represented in the sign-magnitude form, and the word-lengths of the magnitudes of these two polynomials are 13-bit and 3-bit, respectively. The modular adder calculates the 13-bit sum (sum) by adding the product (prod) of the corresponding a[i] and b[j], and the output from the register (acc) as shown in FIG. 2, which can also be mathematically expressed as:

$$sum = \{ \begin{matrix}acc - prod , & if {a}_{sign} {⊕}_{sign} = 1 , \\ acc + prod , & otherwise ,\end{matrix} \qquad ( 25 )$$

where a_{sign} and b_{sign} are the sign bits of the two operands a[i] and b[j], respectively.

The experiment was performed on the Xilinx Artix-7 AC701 FPGA board, which is recommended by NIST for PQC hardware implementation. In addition, since several prior works also used the high-performance Xilinx UltraScale+ FPGA board, we also demonstrate the performance of the present embodiments on this board for more comparisons. The communication and data transmission between FPGA and PC use the universal asynchronous receiver-transmitter (UART) module provided by AC701 device for functionality verification.

We first examine the performance of the modular polynomial multipliers, including systolic architecture (FIG. 2), fast 2-parallel architecture, and fast 4-parallel architecture embodiments described above in key generation, encapsulation, and decapsulation steps of Saber scheme with the standard security level. The experimental results and comparison with prior works are summarized in Table 1. A further comparison of the timing performance is presented in Table 2. The clock frequencies are set as 250 MHz and 133 MHz for UltraScale+ and Artix-7, respectively. It can be seen from Table 1 that our design has a shorter critical path than those of the designs in Zhu and Mera and the same as in Roy.

TABLE 1
Performance of modular polynomial multiplier when n = 256

| | | | | | | Freq. |
|---|---|---|---|---|---|---|
| Design | Device | LUTs | FFs | DSPs | BRAM | [MHz] |
| Roy | Ultrascale+ | 17406 | 5083 | 0 | 0 | 250 |
| Roy (2 Mults.) | Ultrascale+ | 31853 | 8844 | 0 | 0 | 250 |
| Zhu | Ultrascale+ | 13954 | 3943 | 85 | 6 | 100 |
| Systolic.PolyMult | Ultrascale+ | 16971 | 8755 | 0 | 0 | 250 |
| Fast.2.PolyMult | Ultrascale+ | 25831 | 12850 | 0 | 0 | 250 |
| Fast.4.PolyMult | Ultrascale+ | 35306 | 19143 | 64 | 0 | 250 |
| Mera | Artix-7 | 7400 | 7331 | 38 | 2 | 125 |
| Systolic.PolyMult | Artix-7 | 16902 | 8755 | 0 | 0 | 133 |
| Fast.2.PolyMult | Artix-7 | 25854 | 12850 | 0 | 0 | 133 |
| Fast.4.PolyMult | Artix-7 | 35396 | 19143 | 64 | 0 | 133 |

TABLE 2
Timing performance (total latency (unit: clock cycle)/actual latency (unit:μs)) of
modular polynomial multiplier when n = 256

| Design | Device | PolyMult. | KeyGen | Enc | Dec |
|---|---|---|---|---|---|
| Roy | Ultrascale+ | 256/1.02 | 2685/10.74 | 3592/14.37 | 4484/17.94 |
| Roy (2 Mults.) | Ultrascale+ | 128/0.51 | 1552/6.21 | 2205/8.82 | 2911/11.64 |
| Zhu | Ultrascale+ | 81/0.81 | (Not Reported) | 978/9.78 | 1227/12.27 |
| Systolic.PolyMult | Ultrascale+ | 511/2.04 | 2560/10.24 | 3328/13.31 | 4096/16.38 |
| Fast.2.PolyMult | Ultrascale+ | 255/1.02 | 1281/5.12 | 1665/6.66 | 2049/8.20 |
| Fast.4.PolyMult | Ultrascale+ | 127/.51 | 642/2.57 | 834/3.34 | 1026/4.10 |
| Mera | Artix-7 | 1299/10.30 | 11592/92.74 | 15456/123.65 | 19320/154.56 |
| Systolic.PolyMult | Artix-7 | 511/3.83 | 2560/19.20 | 3328/24.96 | 4096/30.72 |
| Fast.2.PolyMult | Artix-7 | 255/1.91 | 1281/9.61 | 1665/12.48 | 2049/15.36 |
| Fast.4.PolyMult | Artix-7 | 127/0.95 | 642/4.82 | 834/6.26 | 1026/7.70 |

For a fair comparison, we focus on the evaluation against the Roy architecture, since both designs use the same clock frequency while the implementation of the Zhu design has a much lower clock frequency. Compared to Roy, the present systolic modular polynomial multiplier has slightly fewer LUTs and less total latency while requiring a larger number of flip-flops (FFs) due to the additional shift registers. Our design achieves 18% and 25% reductions on the LUTs and the clock cycles for all the polynomial multiplications in the Saber scheme. Even though our design requires more FFs in the data-path and shift registers, we argue that it makes a smaller influence on the overall performance on UltraScale+ and Artix-7 FPGA boards, since both devices have a much higher resource budget for FFs than LUTs.

Furthermore, both the polynomial multiplier in Zhu's LWRpro and the compact polynomial multiplier in Zhu and Mera use the Karatsuba algorithm with 8-level and 4-level, respectively. For instance, the compact polynomial multiplier has a long critical path of five adders/subtractors and two multipliers in the interpolation part, which requires two pipelining stages to reduce the critical path for maintaining a high frequency. The compact polynomial multiplier of Zhu and Mera targets the low-area performance, which only requires limited numbers of LUTs, FFs, and only 38 DSP units, as shown in Tables 1. While the compact polynomial multiplier has a lower LUT usage than the embodiments described above, the compact polynomial multiplier suffers from a low speed since it uses degree-64 polynomial multipliers that require 1168 clock cycles for each computation, which causes the actual latency in such a compact design to be around 19 times of the latency in the present fast 4-parallel architecture as presented in Table 2. If we consider the area-time product (ATP) [LUTsxus] as the performance metric, our proposed fast 4-parallel architecture and the prior low-area design yield an ATP of 1.71×10⁵ and 6.86×10⁵, respectively, for the key generation. In other words, our design achieves a 75.07% reduction on the ATP. Besides, the modular polynomial multiplier in Zhu has the lowest clock cycles among all the prior works, while having a lower clock frequency as illustrated in Table 2. In comparison, the present fast 4-parallel architecture requires 14.72% fewer clock cycles and achieves a 65.85% reduction in the actual latency for the encryption. Besides, the present embodiments achieve a 13.24% lower ATP than Zhu (1.36×10⁵ in Zhu versus 1.18×10⁵ in the present embodiments). Moreover, the design in Zhu requires 24.71% more DSPs than the present fast 4-parallel architecture. Thus, the present embodiments achieves significant reductions in latency or the delay (critical path) which leads to reductions in ATP, when comparing to the two prior works that employ the Karatsuba polynomial multiplication.

For the implementation of the entire Saber scheme, the modular polynomial multiplication is implemented by the present fast 4-parallel architecture. Table 3 presents the comparison of the FPGA performance with recent hardware implementations for the PQC schemes, including Saber as well as some other schemes for a more comprehensive comparison. The latency in our design is 52% less than the latency in Roy, where the reduction is mainly from our optimized low-latency modular polynomial multiplier and the hash function block. For example, the total latency of SHA3-256 (needs to process 32-byte, 64-byte, 992-byte, and 1088-byte seeds) operating in the hash function block is reduced from 585 clock cycles to 526 clock cycles in the Saber encapsulation. The rationale behind this latency reduction is as follows. Most open-source packages add stages of pipelining to achieve a high frequency (low critical path) design in order to adapt to general applications. However, the critical path among the prior works are under the NTT-based or schoolbook modular polynomial multiplier that requires addition or multiplication, which is much higher than Keccak core provided in the open-source packages, thus implying that some pipelines are redundant. Different from the prior works, we implement our own hash function block as we aim to reduce the total latency for computing the hash functions by eliminating unnecessary pipelining stages.

TABLE 3
Comparisons with recent PQC implementations

| | | Time in | | | |
|---|---|---|---|---|---|
| | | (μs):KeyGen/Encaps/ | Freq. | Area:LUTs/FFs/DSPs/ | |
| | Plantform | Decaps | [MHz] | BRAM | Scheme |
| Roy | UltraScale+ | 21.8/26.5/32.1 | 250 | 23.6k/9.8k/0/2 | Saber |
| Zhu | UltraScale+ | (Not Reported)/11.6/4.1 | 100 | 34.8k/9.9k/85/6 | Saber |
| Mera | Artix-7 | 3.2k/4.1k/3.8k | 125 | 7.4k/7.3k/28/2 | Saber |
| Dang | UltraScale+ | (Not Reported/60/65 | 322 | 12.5k/11.6k/256/4 | Saber |
| Xing | Artix-7 | 39.2/47.6/62.3 | 161 | 7.4k/4.6k/2/3 | Kyber |
| Zhang | Artix-7 | 40/62.5/24 | 200 | 6.7k/4.1k/2/8 | NewHope |
| Howe | Artix-7 | 45k/45k/47k | 167 | 7.7k/3.5k/1/24 | Frodo |
| Ours | Artix-7 | 19.5/23.6/29.2 | 133 | 41.5k/22.3k/64/2 | Saber |
| Ours | UltraScale+ | 10.2/12.6/15.6 | 250 | 41.5k/22.3k/64/2 | Saber |

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A modular polynomial multiplier comprising:
a plurality of processing elements, each processing element comprising:
a multiplication unit with a first input, a second input and an output, wherein with each of a series of clock cycles, the output of the multiplication unit carries the product of a value provided on the first input and a value provided on the second input;
an addition unit having a first input, a second input and an output wherein the first input is connected to the output of the multiplication unit, and
a delay unit that has an input connected to the output of the addition unit and an output, wherein the input carries an input value and the output provides the input value delayed by one clock cycle;
wherein the first input of the multiplication unit of each processing element carries a respective coefficient of a first polynomial; and
wherein the second input of the multiplication unit of each processing element is connected to one of an input line carrying a sequence of coefficients of a second polynomial having n coefficients and a delay line carrying the sequence of coefficients of the second polynomial delayed by n clock cycles and negated.

2. The modular polynomial multiplier of claim 1 wherein the outputs of delay units in some of the plurality of processing elements are connected to second inputs of addition units of others of the plurality of processing elements to form a series of processing elements.

3. The modular polynomial multiplier of claim 2 wherein the series of processing elements further comprises an initial processing element comprising:
a multiplication unit with a first input, a second input and an output, wherein the first input of the multiplication unit carries a coefficient of the first polynomial and the second input is connected to the input line; and
a delay unit that has an input connected to the output of the multiplication unit and an output connected to a second input of an addition unit of another processing element in the series of processing elements.

4. The modular polynomial multiplier of claim 3 wherein the series of processing elements further comprises a last processing element comprising:
a multiplication unit with a first input, a second input and an output, wherein the first input of the multiplication unit carries a coefficient of the first polynomial and the second input is connected to one of the input line and the delay line;
an addition unit having a first input connected to the output of the multiplication unit of the last processing element, a second input connected to the output of a delay unit of one of the processing elements in the series of processing elements and an output that provides coefficients for a polynomial representing the modulo (xⁿ+1) of the product of the first polynomial and the second polynomial.

5. The modular polynomial multiplier of claim 4 wherein the second input of the multiplication unit of each processing element in the series of processing elements other than the initial processing element is connected to the input line for a respective first number of clock cycles and is connected to the delay line for a respective second number of clock cycles.

6. The modular polynomial multiplier of claim 4 wherein the output of the addition unit of the last processing element provides the coefficients for the polynomial representing the modulo (xⁿ+1) of the product of the first polynomial and the second polynomial as a series of n coefficients with a separate coefficient for each clock cycle of a set of contiguous clock cycles.

7. The modular polynomial multiplier of claim 6 wherein the series of n coefficients for the polynomial representing the modulo (xⁿ+1) of the product of the first polynomial and the second polynomial begins with a most-significant coefficient of the polynomial.

8. A modular polynomial multiplier comprising:
a first modular polynomial multiplier configured to produce a first modular product of a first portion of a first polynomial and a first portion of a second polynomial, the first modular product produced as a first series of coefficients with a separate coefficient at each of a set of clock cycles;
a second modular polynomial multiplier configured to produce a second modular product of a second portion of the first polynomial and a second portion of the second polynomial, the second modular product produced as a second series of coefficients with a separate coefficient at each of the set of clock cycles;
a first delay circuit configured to delay the first series of coefficients by one clock cycle to form a delayed series of coefficients;
a second delay circuit configured to delay a first coefficient in the second series of coefficients by a number of clock cycles equal to the number of coefficients in the second series of coefficients to form a modified series of coefficients; and
an addition unit configured to add coefficients in the delayed series of coefficients to coefficients in the modified series of coefficients.

9. The modular polynomial multiplier of claim 8 wherein the second delay circuit comprises a delay unit, a first switch and a second switch wherein the first switch is positioned between the second modular polynomial multiplier and an input of the delay unit and the second switch is positioned between an output of the delay unit and the addition unit.

10. The modular polynomial multiplier of claim 9 wherein the second delay circuit further comprises a negation unit that negates the first coefficient of the second series of coefficients.

11. The modular polynomial multiplier of claim 8 wherein the first modular polynomial multiplier comprises:
a plurality of processing elements, each processing element comprising:
a multiplication unit with a first input, a second input and an output, wherein with each clock cycle, the output of the multiplication unit carries the product of a value carried on the first input and a value carried on the second input;
an addition unit having a first input, a second input and an output wherein the first input is connected to the output of the multiplication unit; and
a delay unit that has an input connected to the output of the addition unit and an output, wherein the input carries an input value and the output provides the input value delayed by one clock cycle;
wherein the first input of the multiplication unit of each processing element carries a respective coefficient of the first portion of the first polynomial; and
wherein the second input of the multiplication unit of each processing element is connected to one of an input line carrying a sequence of coefficients of the first portion of the second polynomial and a delay line carrying the sequence of coefficients of the first portion of the second polynomial negated and delayed by a number of clock cycles equal to a number of coefficients in the first portion of the second polynomial.

12. The modular polynomial multiplier of claim 8 wherein the first modular polynomial multiplier comprises:
a third modular polynomial multiplier configured to produce a third modular product of a first sub-polynomial of the first portion of the first polynomial and a first sub-polynomial of the first portion of the second polynomial, the third modular product produced as a third series of coefficients with a separate coefficient at each of a set of clock cycles;
a fourth modular polynomial multiplier configured to produce a fourth modular product of a second sub-polynomial of the first portion of the first polynomial and a second sub-polynomial of the first portion of the second polynomial, the fourth modular product produced as a fourth series of coefficients with a separate coefficient at each of the set of clock cycles;
a third delay circuit configured to delay the third series of coefficients by one clock signal to form a second delayed series of coefficients;
a fourth delay circuit configured to delay a first coefficient in the fourth series of coefficients by a number of clock cycles equal to the number of coefficients in the fourth series of coefficients to form a second modified series of coefficients; and
a second addition unit for adding coefficients in the second delayed series of coefficients to coefficients in the second modified series of coefficients.

13. The modular polynomial multiplier of claim 12 wherein the third modular polynomial multiplier comprises:
a plurality of processing elements, each processing element comprising:
a multiplication unit with a first input, a second input and an output, wherein with each clock cycle, the output of the multiplication unit carries the product of a value carried on the first input and a value carried on the second input;
an addition unit having a first input, a second input and an output wherein the first input is connected to the output of the multiplication unit; and
a delay unit that has an input connected to the output of the addition unit and an output, wherein the input carries an input value and the output provides the input value delayed by one clock cycle;
wherein the first input of the multiplication unit of each processing element carries a respective coefficient of the first sub-polynomial of the first portion of the first polynomial; and
wherein the second input of the multiplication unit of each processing element is connected to one of an input line carrying a sequence of coefficients of the first sub-polynomial of the first portion of the second polynomial and a delay line carrying the sequence of coefficients of the first sub-polynomial of the first portion of the second polynomial negated and delayed by a number of clock cycles equal to a number of coefficients in the first sub-polynomial of the first portion of the second polynomial.

14. The modular polynomial multiplier of claim 8 wherein the first modular polynomial multiplier is structurally identical to the second modular polynomial multiplier.

15. The modular polynomial multiplier of claim 12 wherein the third modular polynomial multiplier is structurally identical to the fourth modular polynomial multiplier.

16. A modular polynomial multiplier comprising:
a first circuit receiving a first sub-polynomial of a first polynomial and a first sub-polynomial of a second polynomial and producing a modular product of the first sub-polynomial of the first polynomial and the first sub-polynomial of the second polynomial; and
a second circuit receiving a second sub-polynomial of the first polynomial and a second sub-polynomial of the second polynomial and producing a modular product of the second sub-polynomial of the first polynomial and the second sub-polynomial of the second polynomial; wherein the first circuit and the second circuit are identical to each other.

17. The modular polynomial multiplier of claim 16 wherein the first circuit comprises:
a first sub-circuit producing a modular product of a first sub-sub-polynomial of the first sub-polynomial of the first polynomial and a first sub-sub-polynomial of the first sub-polynomial of the second polynomial; and
a second sub-circuit producing a modular product of a second sub-sub-polynomial of the first sub-polynomial of the first polynomial and a second sub-sub-polynomial of the first sub-polynomial of the second polynomial; wherein the first sub-circuit is identical to the second sub-circuit.

18. The modular polynomial multiplier of claim 17 wherein the modular product of the first sub-circuit is a first series of coefficients and the modular product of the second sub-circuit is a second series of coefficients and the first circuit further comprises:
a first delay circuit that delays the first series of coefficients to form a delayed series of coefficients;
a second delay circuit that delays a first coefficient of the second series of coefficients so that the first coefficient becomes a last coefficient of a modified series of coefficients; and
an addition circuit that adds the delayed series of coefficients to the modified series of coefficients.

19. The modular polynomial multiplier of claim 18 wherein the modular product of the first circuit comprises a third series of coefficients and the modular product of the second circuit comprises a fourth series of coefficients and the modular polynomial multiplier further comprises:
a third delay circuit that delays the third series of coefficients to form a second delayed series of coefficients;
a fourth delay circuit that delays a first coefficient of the fourth series of coefficients so that the first coefficient becomes a last coefficient of a second modified series of coefficients; and
an addition circuit that adds the second delayed series of coefficients to the second modified series of coefficients.

20. The modular polynomial multiplier of claim 17 wherein the first sub-circuit comprises:
a plurality of processing elements, each processing element comprising:
a multiplication unit with a first input, a second input and an output, wherein with each clock cycle of a series of clock cycles, the output of the multiplication unit carries the product of a value carried on the first input and a value carried on the second input;
an addition unit having a first input, a second input and an output wherein the first input is connected to the output of the multiplication unit; and
a delay unit that has an input connected to the output of the addition unit and an output, wherein the input carries an input value and the output provides the input value delayed by one clock cycle;
wherein the first input of the multiplication unit of each processing element carries a respective coefficient of the first sub-sub-polynomial of the first sub-polynomial of the first polynomial; and
wherein the second input of the multiplication unit of each processing element is connected to one of an input line carrying a sequence of coefficients of the first sub-sub-polynomial of the first sub-polynomial of the second polynomial and a delay line carrying the sequence of coefficients of the first sub-sub-polynomial of the first sub-polynomial of the second polynomial negated and delayed by a number of clock cycles equal to a number of coefficients in the first sub-sub-polynomial of the first sub-polynomial of the second polynomial.
